(19) United States
(12) Patent Application Publication
(10) Pub. No.: US 2007/0223149 A1
(43) Pub. Date: Sep. 27, 2007

(54) NANOCONTACTS HAVING IMPROVED CONTACT SHAPE

(76) Inventors: Young Keun Kim, Seoul (KR); Se-Dong Kim, Gyeongsangbuk-do (KR); Byong-Sun Chun, Seoul (KR)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/277,667

(22) Filed: Mar. 28, 2006

(30) Foreign Application Priority Data
Mar. 21, 2006 (KR) 2006-0025632

(51) Int. Cl. G11B 5/127; G11B 5/33

(52) U.S. Cl. 360/324.1; 977/762

(57) ABSTRACT

A nanocontact between contact wires is provided. The contact plane of the first nanocontact wire has a quadrant shape. The contact plane of the second nanocontact wire contacting the first nanocontact wire has a quadrant shape symmetrical with the quadrant contact plane of the first nanocontact wire with respect to origin. Thus, magnetization directions of the first and second nanowires are opposite to each other, regardless of initial spin moment orientation of the nanowire. When domain wall is formed, the thickness of the domain wall becomes constant, such that ballistic magnetoresistance ratio can be constant and reproducible.

### PRIORITY

This application claims priority under 35 U.S.C. §119 to an application entitled “Nanocontacts Having Improved Contact Shape” filed in the Korean Intellectual Property Office on Mar. 21, 2006 and allocated Serial No. 2006-25632, the contents of which are incorporated herein by reference.

### BACKGROUND OF THE INVENTION

1. Field of the Invention

The present invention relates generally to a nanocontact, and in particular, to a nanocontact that constantly maintains ballistic magnetoresistance (BMR) by implementing domain wall with a constant thickness, regardless of initial spin moment orientation.

2. Description of the Related Art

With the growth of mobile application markets, the demand for large-capacity nonvolatile memory and small-sized hard disc drive (HDD) is increasing. Ballistic magnetoresistance (BMR) devices are studied for the nonvolatile memory and HDD components.

The ballistic magnetoresistance device can obtain very high magnetoresistance ratio in giant magnetoresistance (GMR) device or a tunneling magnetoresistance (TMR) device. Thus, the ballistic magnetoresistance device can be used as an HDD read head with a recording density of 1 Tb (Tera bit)/in² or more. In addition, since the ballistic magnetoresistance device expresses bit through magnetic switching, its operating speed is very fast. Further, the ballistic magnetoresistance device has a nonvolatility and a simplified structure and can be integrated highly. Therefore, it can be used to implement a next generation memory device. That is, the ballistic magnetoresistance device can be used as a substitute for flash memory, dynamic random access memory (DRAM), electrically erasable programmable read only memory (EEPROM), or static random access memory (SRAM) in fields of portable terminal, computer, or network.

Also, the ballistic magnetoresistance device has a strong radiation resistance and thus is applicable to military missile or aerospace field.

As a conventional ballistic magnetoresistance, Ni nanocontact is disclosed in Physical Review Letters, N. Garcia, M. Munoz, and Y. -W. Zhao, Volume 14, 2923-2926, (1999). The Ni nanocontact shows magnetoresistance ratio of 200% or more due to domain wall at room temperature and for an applied magnetic field of 100 Oe. Also, domain wall that is unstable and has no reproducibility is disclosed in Journal of Applied Physics, K. Miyake, K. Shigeto, Y. yokoyama, T. Ono, K. Mibu, T. Shinjo, Volume 97, 014309-1˜6, (2005).

FIGS. 1(a) and 1(b) illustrate nanocontacts forming domain walls with different thickness according to initial spin moment orientation of contact wire when a contact length is 0 nm in a conventional nanocontact structure.

A width of one contact wire is 150 nm and a width of another contact wire is 125 nm. A width of contact plane of both contact wires is 2-15 nm and its length x is 0 nm. In an initial state, the spin moment orientations of the contact wire are different. When a magnetic field of 100 Oe is applied to the right contact wire for t₁ (300 pico seconds), a domain wall is formed in the right contact wire. At t₂ (600 pico seconds), the domain wall moves in a direction of the contact area of the contact wire. The domain wall between the contact wires as the final results after 3-4 nano seconds have different thickness from each other. That is, in FIG. 1(a), the final width of the domain wall at the contact area of the contact wires is 58 nm. In FIG. 1(b), the final width of the domain wall at the contact area of the contact wires is 175 nm.

FIGS. 2(a) and 2(b) illustrate nanocontacts forming domain walls with different thickness according to initial spin moment orientation of contact wire when a contact length is 10 nm in a conventional nanocontact structure.

A width of one contact wire is 150 nm and a width of another contact wire is 125 nm. A width of contact plane of both contact wires is 2-15 nm and its length x is 3-20 nm. In an initial state, the spin moment orientations of the contact wire are different. When a magnetic field of 100 Oe is applied to the right contact wire for t₁ (300 pico seconds), a domain wall is formed in the right contact wire. At t₂ (600 pico seconds), the domain wall moves in a direction of the contact area of the contact wire. The domain wall between the contact wires as the final results after 3-4 nano seconds have different thickness from each other. That is, in FIG. 1(a), the final width of the domain wall at the contact area of the contact wires is 60 nm. In FIG. 1(b), the final width of the domain wall at the contact area of the contact wires is 180 nm.

The ballistic magnetoresistance having the conventional contact shape has different thickness of the domain walls between the contact wires when a magnetic field is applied according to the initial spin state of the contact wire. Therefore, the ballistic magnetoresistance inversely proportional to the thickness of the domain wall is changed, resulting in degradation of the device reliability.

Therefore, to secure the reliability of the ballistic magnetoresistance ratio, it is necessary to obtain nanocontacts having domain wall with constant thickness, regardless of initial spin moment orientation of the contact wire. That is, the ballistic magnetoresistance at the domain wall of the nanocontacts is required to obtain the shape of the stable nanocontact area regardless of initial spin moment orientation of the contact wire.

### SUMMARY OF THE INVENTION

An object of the present invention is to substantially solve at least the above problems and/or disadvantages and to provide at least the advantages below. Accordingly, an object of the present invention is to provide a nanocontact having domain wall with constant thickness between contact wires, regardless of initial spin moment orientations of contact wire.

Another object of the present invention is to provide a nanocontact that can constantly maintain ballistic magnetoresistance of contact area between contact wires, regardless of initial spin moment orientations of contact wire.

According to one aspect of the present invention, a nanocontact includes a first contact wire in which a contact plane includes a contact area formed in a quadrant shape, and a second contact wire contacting the first contact wire in the contact area, the second contact wire having a contact plane formed in a quadrant shape symmetrical with the quadrant contact plane of the first contact wire with respect to origin.

According to another aspect of the present invention, a nanocontact includes a first contact wire in which a contact plane includes a contact area formed in an inclined shape, and a second contact wire contacting the first contact wire in the contact area, the second contact wire having a contact plane formed at an inclined angle symmetrical with the inclined angle of the contact plane of the first contact wire.

### BRIEF DESCRIPTION OF THE DRAWINGS

The above and other objects, features and advantages of the present invention will become more apparent from the following detailed description when taken in conjunction with the accompanying drawings in which:

FIGS. 1(a) and 1(b) illustrate nanocontacts forming domain walls with different thickness according to initial spin moment orientation of contact wires when the contact length is 0 nm in a conventional nanocontact structure;

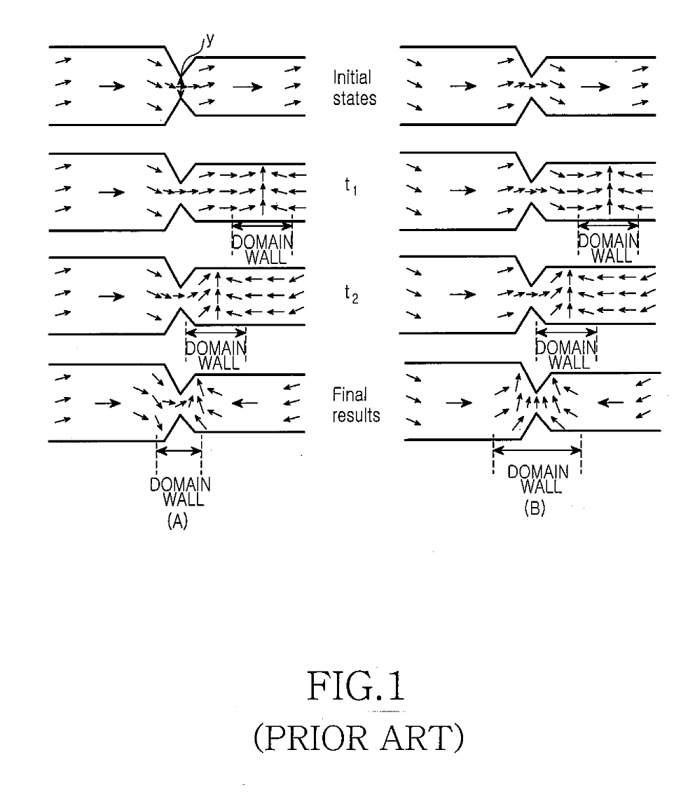

FIGS. 2(a) and 2(b) illustrate nanocontacts forming domain walls with different thickness according to initial spin moment orientation of contact wires when a contact length is 10 nm in a conventional nanocontact structure;

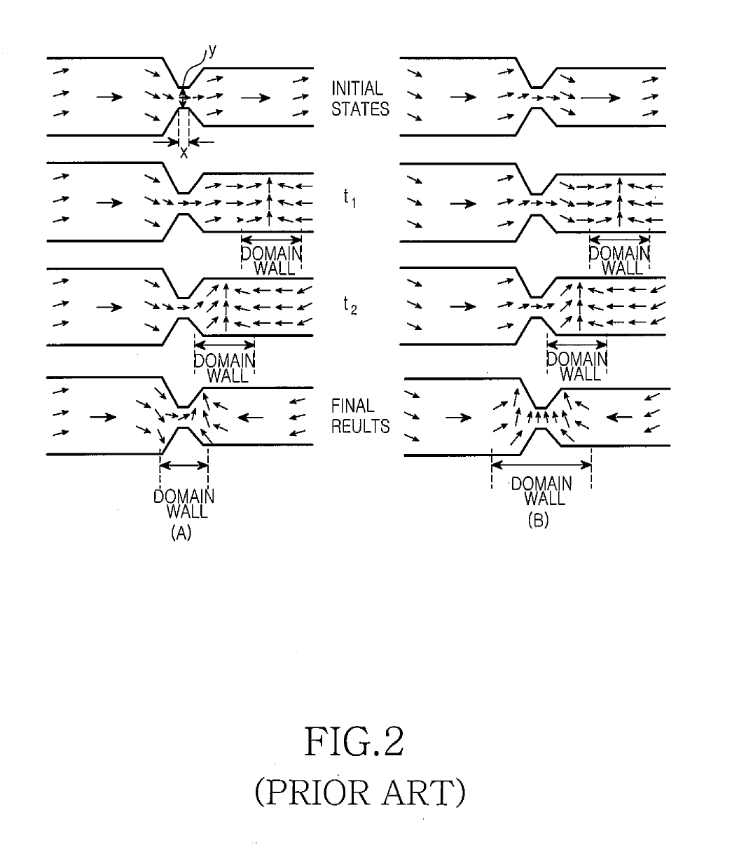

FIGS. 3(a) and 3(b) illustrate nanocontacts forming domain walls with equal thickness regardless of initial spin moment orientation of contact wire when a contact length is 0 nm in a nanocontact structure according to a first embodiment of the present invention;

FIGS. 4(a) and 4(b) illustrate nanocontacts forming domain walls with equal thickness regardless of initial spin moment orientation of contact wire when a contact length is 10 nm in a nanocontact structure according to a first embodiment of the present invention; and

FIGS. 5(a) and 5(b) illustrate nanocontacts forming domain walls with equal thickness regardless of initial spin moment orientation of contact wire when a contact length is 10 nm in nanocontact structures according to first and second embodiments of the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

To improve the contact area of nanocontact wires, thickness of domain walls becomes constant when magnetization directions of first and second nanowires are opposite to each other by applying a magnetic field regardless of initial spin moment orientation of contact wire. Thus, ballistic magnetoresistance ratio can be constant and reproducible.

Hereinafter, nanocontacts when Ni₈₁Fe₁₉ nanowires are used on both sides will be described. The drawings showing the nanocontacts of the present invention illustrate thin films deposited on a substrate, seen from topside.

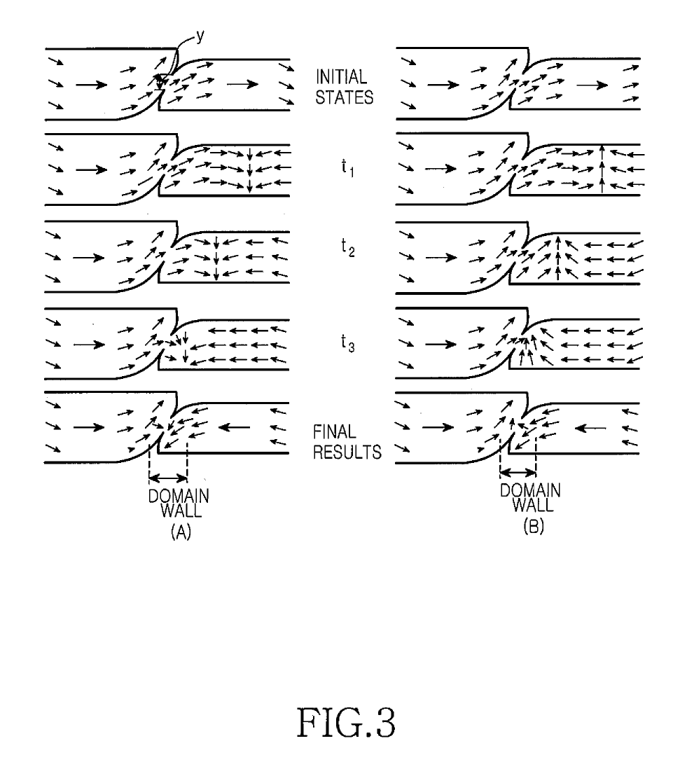

FIGS. 3(a) and 3(b) illustrate nanocontacts forming domain walls with equal thickness regardless of initial spin moment orientation of contact wire when a contact length is 0 nm in a nanocontact structure according to a first embodiment of the present invention.

In the first contact wire, a contact plane including a contact area has a quadrant. The second contact wire contacts the first contact wire in a contact area and has a quadrant-shaped contact plane symmetrical with the quadrant contact plane of the first contact wire with respect to origin. Both ends of the quadrant are contacted with each other. The width of the first contact wire is 150 nm and the width of another contact wire is 125 nm.

A width y of the contact plane of both contact wires is 2-15 nm and a length x is 0 nm. In an initial state, the spin moment orientations of the contact wire are different. When a magnetic field of 100 Oe is applied to the right contact wire for t₁ (300 pico seconds), a domain wall is formed in the right contact wire. At t₂ (600 pico seconds) and t₃ (1 nano seconds), the domain wall moves in a direction of the contact area of the contact wire. The domain wall between the contact wires as the final results after 3-4 nano seconds have equal thickness from each other. That is, although the spin moment orientations of the domain wall are different with the time elapse in FIGS. 3(a) and 3(b), the domain walls with constant thickness can be finally formed regardless of initial spin moment orientations. That is, the final width of the domain wall at the contact area of the contact wires is 175 nm.

The domain wall between the contact wires as the final results has a thickness of 60 nm, regardless of initial spin moment orientations of contact wires.

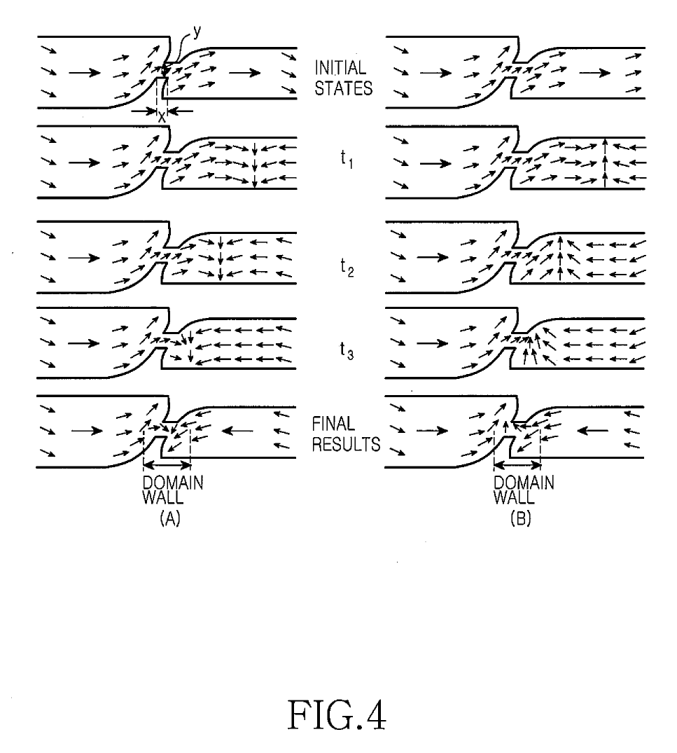

FIGS. 4(a) and 4(b) illustrate nanocontacts forming domain walls with equal thickness regardless of initial spin moment orientation of contact wire when a contact length is 10 nm in a nanocontact structure according to a first embodiment of the present invention.

In the first contact wire, a contact plane including a contact area has a quadrant. The second contact wire contacts the first contact wire in a contact area and has a quadrant-shaped contact plane symmetrical with the quadrant contact plane of the first contact wire with respect to origin. The area contacting the quadrant has a rectangular shape.

A width of one contact wire is 150 nm and a width of another contact wire is 125 nm. A width y of the contact plane of both contact wires is 2-15 nm or less, and a length x is 3-20 nm. In an initial state, the spin moment orientations of the contact wire are different. When a magnetic field of 100 Oe is applied to the right contact wire for t₁ (300 pico seconds), a domain wall is formed in the right contact wire. At t₂ (600 pico seconds) and t₃ (1 nano seconds), the domain wall moves in a direction of the contact area of the contact wire. The domain wall between the contact wires as the final results after 3-4 nano seconds has a thickness of 62 nm, regardless of initial spin moment orientations of contact wires.

That is, if magnetization reversal of two nanowires having the shape of the contact area according to the present invention occurs, magnetic moment of both nanocontacts controls the direction of the magnetic moment such that they are always in opposite direction by shape anisotropy, regardless of the initial state. Consequently, domain walls have constant thickness. Thus, the ballistic magnetoresistance ratio becomes constant and the stable ballistic magnetoresistance ratio device can be implemented.

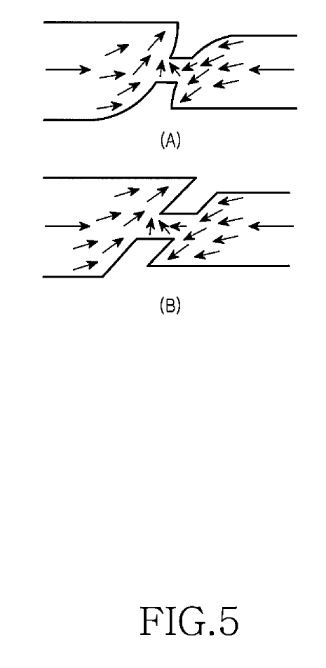

FIGS. 5(a) and 5(b) illustrate final nanocontacts forming domain walls with equal thickness regardless of initial spin moment orientation of contact wire when a contact length is 10 nm in nanocontact structures according to first and second embodiments of the present invention. Specifically, FIG. 5(a) illustrates domain walls between a first nanowire and a second nanowire when a length of the contact area is 10 nm according to the first embodiment of the present invention, and FIG. 5(b) illustrates a final nanocontact forming domain wall with equal thickness between the first nanowire and the second nanowire, regardless of initial spin moment orientations of contact wire, when a length of the contact area is 10 nm in a nanocontact structure according to the second embodiment of the present invention.

According to the nanocontact structure of the second embodiment, in the first contact wire, a contact plane including a contact area has a predetermined inclined shape. The second contact wire contacts the first contact wire in a contact area and has a contact plane forming an inclined angle symmetrical with the inclined angle of the first contact wire.

Although the use of NiFe (especially, Ni₈₁Fe₁₉) as the contact wire has been described above, materials (e.g., Co or Ni) in which there are more up spin than down spin in a Fermi energy, may also be used.

As described above, the contact area of two contact wires constituting the nanocontacts is formed in a quadrant shape symmetrical with origin. Thus, domain wall occurring when the magnetization directions of the first and second nanowires are opposite to each other by apply a magnetic field without regard to the initial spin moment orientation of the contact wire can have constant thickness. Consequently, it is possible to provide constant and reproducible ballistic magnetoresistance ratio.

Also, contact wire described above may be implemented as a thin film deposited on a substrate or another thin film formed by a conventional thin film formation technology.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A nanocontact comprising:
a first contact wire in which a contact plane including a contact area is formed in a quadrant shape; and
a second contact wire contacting the first contact wire in the contact area, the second contact wire having a contact plane formed in a quadrant shape symmetrical with the quadrant contact plane of the first contact wire with respect to origin.

2. The nanocontact of claim 1, wherein the contact area has a length of 2-20 nm and a width of 2-15 nm.

3. The nanocontact of claim 1, wherein the contact area has a width of 2-15 nm.

4. The nanocontact of claim 1, wherein the first and second contact wires are formed of Ni, Co, or NiFe.

5. A nanocontact comprising:
a first contact wire in which a contact plane includes a contact area formed in an inclined shape; and
a second contact wire contacting the first contact wire in the contact area, the second contact wire having a contact plane formed at an inclined angle symmetrical with the inclined angle of the contact plane of the first contact wire.

6. The nanocontact of claim 5, wherein the contact area has a length of 3-20 nm.

7. The nanocontact of claim 5, wherein the contact area has a width of 2-15 nm.

8. The nanocontact of claim 5, wherein the first and second contact wires are formed of Ni, Co, or NiFe.

9. A nanocontact comprising:
a first contact thin film in which a contact plane including a contact area is formed in a quadrant shape; and
a second contact thin film contacting the first contact thin film in the contact area, the second contact thin film having a contact plane formed in a quadrant shape symmetrical with the quadrant contact plane of the first contact thin film with respect to origin.

10. The nanocontact of claim 10, wherein the contact area has a length of 2-20 nm and a width of 2-15 nm.

11. The nanocontact of claim 10, wherein the first and second contact thin films are formed of Ni, Co, or NiFe.

12. A nanocontact comprising:
a first contact thin film in which a contact plane includes a contact area formed in an inclined shape; and
a second contact thin film contacting the first contact thin film in the contact area, the second contact thin film having a contact plane formed at an inclined angle symmetrical with the inclined angle of the contact plane of the first contact thin film.

13. The nanocontact of claim 12, wherein the contact area has a length of 3-20 nm.

14. The nanocontact of claim 12, wherein the contact area has a width of 2-15 nm.

15. The nanocontact of claim 12, wherein the first and second contact thin films are formed of Ni, Co, or NiFe.
